(19) United States
(12) Patent Application Publication
(10) Pub. No.: US 2011/0188646 A1
(43) Pub. Date: Aug. 4, 2011

(54) Adaptive Communication Device with Telephonic Interface Capabilities

(76) Inventor: Brian Taylor, West Allis, WI (US)

(21) Appl. No.: 12/984,435

(22) Filed: Jan. 4, 2011

Related U.S. Application Data
(60) Provisional application No. 61/300,751, filed on Feb. 2, 2010.

(51) Int. Cl. H04M 11/00

(52) U.S. Cl. 379/93.01

(57) ABSTRACT

The present invention is an adaptive communication device with telephonic interface capabilities which allows the device to interface with standard telephony. The adaptive communication device is comprised of a user interface with a digitized user interface and movement transducer.

### CROSS-REFERENCE TO RELATED APPLICATIONS

This application claims priority to U.S. Provisional Application No. 61/300,751 filed on Feb. 2, 2010.

### FIELD OF INVENTION

The present invention relates to the field communication devices and more particularly to a communication device with telephonic interface capabilities.

### BRIEF DESCRIPTION OF THE DRAWINGS

FIG. 1 is a flowchart illustrating input using digitized binary-input user interface.

FIG. 2 illustrates an exemplary embodiment of a digitized binary-input user interface for an adaptive communication device with telephonic interface capabilities.

FIG. 3a illustrates an exemplary embodiment of a digitized cursor-input user interface with phrases for an adaptive communication device with telephonic interface capabilities in which the movement transducer is a stylus.

FIG. 3b illustrates an exemplary embodiment of a digitized cursor-input user interface with phrases for an adaptive communication device with telephonic interface capabilities in which the movement transducer is a mouse.

FIG. 4a illustrates an exemplary embodiment of a digitized cursor-input user interface with pictures for an adaptive communication device with telephonic interface capabilities in which the movement transducer is a stylus.

FIG. 4b illustrates an exemplary embodiment of a digitized cursor-input user interface with pictures for an adaptive communication device with telephonic interface capabilities in which the movement transducer is a mouse.

FIG. 5a illustrates an exemplary embodiment of a digitized cursor-input user interface with a keyboard for an adaptive communication device with telephonic interface capabilities in which the movement transducer is a stylus.

FIG. 5b illustrates an exemplary embodiment of a digitized cursor-input user interface with a keyboard for an adaptive communication device with telephonic interface capabilities in which the movement transducer is a mouse.

FIG. 6 is an exemplary embodiment of a digitized user interface selection interface for an adaptive communication device with telephonic interface capabilities.

FIG. 7 is an exemplary embodiment of an adaptive communication device with telephonic interface capabilities for use with a telephone.

### GLOSSARY

As used herein, the term “binary-input” refers to any input by a user using at least two differentiable actions, such as a first button and a second button or one button of two different durations, entered in series to create a binary string which corresponds to an action.

As used herein, the term “binary string” refers to multiple binary entries entered in series.

As used herein, the term “body part” refers to any portion of the human body which is capable of performing an electro-mechanically discernable movement.

As used herein, the term “buffering capability” means the ability to store data selected by choosing letters, images, phrases, phonetic, non-phonetic or other input and concatenate such data with or without the use of time delay to create coherent, audible simulated speech.

As used herein, the term “button” refers to any structure or device known in the art to provide a measurable manipulation, including, but not limited to, depressible buttons, turning mechanisms, spinning mechanisms, touch pads, triggers, levers, switches and suck-and-blow devices. Buttons may also be manipulated by any part of the body. The term “button” may also include structures or devices that are not physically manipulated, including, but not limited to, microphones, cameras or other sensors.

As used herein, the term “cursor-input” refers to any input by a user using a touch screen, a stylus, a pointer device, a mouse or other selection device capable of selecting an option from a menu by physically orienting a selection indicator to select an option.

As used herein, the term “defined length” refers to the set number of binary inputs entered in series to make a selection. For an adaptive communication device with telephonic interface capabilities, binary-input is of a defined length, or set number of inputs, as opposed to Morse code style inputs, which vary in length.

As used herein, the term “digitized user interface” refers to the display surface of a communication device which allows the user to input information and/or make selections using his or her finger or another tool, e.g., a pointer device.

As used herein, the term “electro-mechanically discernable movement” any repeatable movement by a body part which may be electronically or mechanically measured and converted into an electrical signal. Electro-mechanically discernable movements include, but are not limited to, movements of the fingers, limbs, and other muscle groups, vocal utterances, eye movement, and any other movement generated by a body part that may be discerned by electrical or mechanical means.

As used herein, the term “grasping component” refers to any structure known in the art to facilitate grasping of a movement transducer or otherwise releasably attach a movement transducer to a body part.

As used herein, the term “hollow” means a closed housing which is not solid or filled.

As used herein, the term “hovering capability” refers to the ability of a stylus or any pointing device to send an electric signal to an interface without direct physical contact to make a selection of data. For example, a stylus with hovering capability may allow a user to make a selection from a digitized user interface without the need to click or make a physical contact between the tool and the digitized user interface.

As used herein, the term “LC circuit” means a circuit consisting of an inductor and a capacitor which may be used to either generate a signal at a particular frequency or pick out a signal of a particular frequency from a more complex signal.

As used herein, the term “mounting component” refers to any structure or device known in the art to provide a means for securing an adaptive communication device with telephonic interface capabilities to a surface. For example, an adaptive communication device with telephonic interface capabilities may be secured to structures including, but not limited to, a wall, desk, ceiling, wheelchair, bed or other surface which may be accessed by a user of an adaptive communication device with telephonic interface capabilities, and mounting components may include structures or devices existing on an adaptive communication device with telephonic interface capabilities or a structure to which one is attached and structures or devices supplied separately from an adaptive communication device or structures to which one is attached.

As used herein, the term “movement transducer” refers to any structure or device known in the art to convert mechanical energy into electrical energy.

As used herein, the term “pointer device” means a device used to select data from a visual interface such as a mouse, button, digitized user interface, pointer or other device used for selecting data.

As used herein, the term “quasi unique audio-linguistic concept” refers to any selection a user may make with an adaptive communication device with telephonic interface capabilities, including, but not limited to, words, letters, phrases, sentences, numbers, pictures, graphics, commands, actions and combinations of these communicative elements.

As used herein, the term or “stylus” refers to a pen-shaped device used on a surface configured to receive and respond to an electrical signal with or without direct contract between the stylus and the configured surface.

As used herein, the term “telephony” refers to a system of telecommunications in which telephonic equipment is employed in the transmission of speech or other sound between points, with or without the use of wires.

As used herein, the term “user interface” refers to the aspects of communication device which can be seen, heard, touched or otherwise perceived by a user, and the commands and mechanisms the user uses to control its operation and input data.

As used herein, the term “wired connection” refers to a connection using a wire that allows communication between an adaptive communication device with telephonic interface capabilities and another component, such as a movement transducer or electronic interface module. Wired connections include, but are not limited to, USB, Ethernet, coax, optical fiber, or any other wired connections known in the art to enable communication between an adaptive communication device with telephonic interface capabilities and other components.

As used herein, the term “wireless connection” refers to a connection that allows communication between an adaptive communication device with telephonic interface capabilities and another component, such as a movement transducer or electronic interface module, that does not require a wired connection. Wireless connections include, but are not limited to, Bluetooth and wifi connections and any other wireless connection known in the art to enable communication between an adaptive communication device with telephonic interface capabilities and other components.

### BACKGROUND

Aphasia is a condition in which an individual experiences impairment or loss of the ability to communicate by verbal speech or by writing, or has decreased ability to understand written or spoken language, due to a brain injury, illness or disease. Aphasia affects about one million Americans, or about 1 in 250 people, and is more common than Parkinson's disease, cerebral palsy or muscular dystrophy. More than 100,000 Americans acquire the disorder each year.

Many individuals afflicted by a brain injury, stroke, or other injury caused by trauma may suffer from aphasia. The partial or total inability to communicate through verbal speech or written language makes it difficult for professional caregivers and family members to ascertain the needs of the patient and to provide the appropriate care and assistance.

Depending on the severity of the brain injury or disease, the ability of an individual to communicate varies. The ability to communicate is particularly important in a hospital setting or long-term care facility where a lack of communication makes it difficult for the healthcare provider to understand the patient's needs and to respond with appropriate care.

Numerous communication devices which assist individuals with impaired verbal communication skills exist in the prior art. For example, U.S. Pat. No. 7,389,232 (Bedford '232) discloses a portable communication device and learning tool for use by speech impaired individuals or monolinguistic individuals. The user of the portable communication device depresses or touches indicia-bearing units or depressible keys to activate an output signal in the form of a visually perceptible signal or an audibly perceptible sound. The device disclosed by Bedford '232, however, is difficult to use for individuals with limited dexterity and can only be used to communicate with individuals in the same room as the user.

Other portable communication devices known in the art, such as Say-It! SAM Tablet XP1™ incorporate a digitized user interface for ease of use; however, they are not compatible with other communication devices and cannot be used in conjunction with other modes of communication.

It is desirable to have an adaptive communication device which interfaces with standard telephony.

It is desirable to have an adaptive communication device which can be used by individuals with limited dexterity.

It is desirable to have an adaptive communication device which may be used with both cursor-input and binary-input.

### SUMMARY OF THE INVENTION

The present invention is an adaptive communication device with telephonic interface capabilities which allows the device to interface with standard telephony. The adaptive communication device is comprised of a movement transducer which detects a movement by electro-mechanical means and converts the signal into an electrical signal which is received by a digitized user interface. The digitized user interface also contains a plurality of quasi-unique audio-linguistic concepts, which a user selects using the movement transducer. The quasi-unique audio-linguistic concepts may be emitted using a sound emitting hardware component or transmitted over a standard phone line using an electronic interface module.

### DETAILED DESCRIPTION OF INVENTION

For the purpose of promoting an understanding of the present invention, references are made in the text to exemplary embodiments of an adaptive communication device with telephonic interface capabilities, only some of which are described herein. It should be understood that no limitations on the scope of the invention are intended by describing these exemplary embodiments. One of ordinary skill in the art will readily appreciate that alternate but functionally equivalent materials, features and components may be used. The inclusion of additional elements may be deemed readily apparent and obvious to one of ordinary skill in the art. Specific elements disclosed herein are not to be interpreted as limiting, but rather as a basis for the claims and as a representative basis for teaching one of ordinary skill in the art to employ the present invention.

It should be understood that the drawings are not necessarily to scale; instead emphasis has been placed upon illustrating the principles of the invention. In addition, in the embodiments depicted herein, like reference numerals in the various drawings refer to identical or near identical structural elements.

Moreover, the terms “substantially” or “approximately” as used herein may be applied to modify any quantitative representation that could permissibly vary without resulting in a change in the basic function to which it is related.

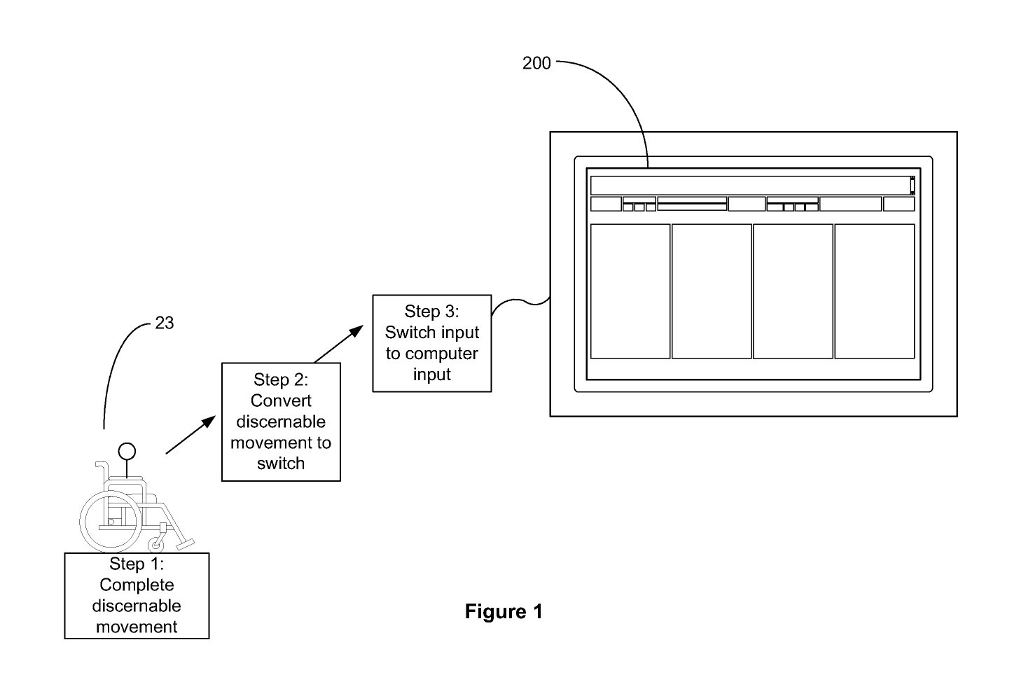

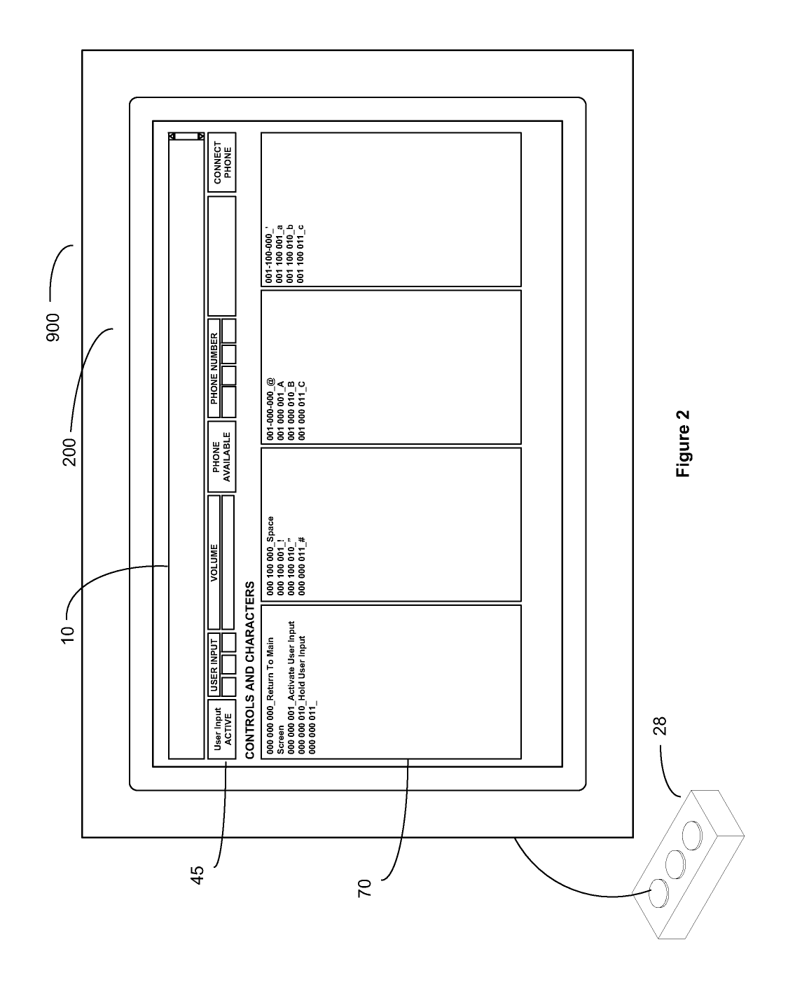

In cases where a user may not be able to manipulate a pointer or other device to control a cursor, a user may utilize any electro-mechanically discernable movement to generate binary-input. For example, some users may have limited mobility and only be able to push a button or otherwise move controllably in one or two ways, such as a shoulder shrug, elbow twitch or even make a vocal noise. These users may be able to use adaptive communication device with telephonic interface capabilities 900 with digitized binary-input user interface 200, as illustrated in FIGS. 1 and 2.

FIG. 1 is a flowchart illustrating input using digitized binary-input user interface. As Step 1, user 23 completes an electro-mechanically discernable movement, which is sensed by a movement transducer and transformed into a switch input (electrical signal) in Step 2. In Step 3, the switch input is relayed to adaptive communication device with telephonic interface capabilities 900. User 23 repeats further discernable movements to enter a binary string which corresponds to a quasi-unique audio-linguistic concept.

Digitized binary-input user interface 200 receives input similar to Morse code dots and dashes. Morse code uses a series of short and long signals which correspond to letters or numbers. The number of short or long characters for each letter varies, and silent spaces mark the end of letters and words. Disabled or physically handicapped people, however, may not be able to enter short and long signals with proper spacing. For example, an elderly user that enters information slowly may end up with too long of a pause between signals, resulting in a mis-entry.

To allow for slow signal entry, adaptive communication device with telephonic interface capabilities 900 adapted with digitized binary-input user interface 200 uses a two-signal input system, representing 1s and 0s instead of dots and dashes, with a standardized number of characters needed for each input. For example, in the exemplary embodiment shown in FIG. 2, communicative selection portion 70 contains a 9-character code of all zeros for the option “Main Menu.” By standardizing the number of characters for selecting an option, a user can pause as long as necessary between input characters and full selection codes.

While in the exemplary embodiment shown in FIG. 2 binary strings are 9-characters, in further exemplary embodiments, binary strings may be any set number of characters to accommodate more or fewer quasi-unique audio-linguistic concepts. As shown in FIG. 2, quasi-unique audio-linguistic concepts are arranged in four columns. In further exemplary embodiments, quasi-unique audio-linguistic concepts may be arranged in more or fewer columns. Within columns, quasi-unique audio-linguistic concepts may be arranged alphabetically, based on statistical relevance to a user's condition or frequency of use, or as determined by a user's preference.

In still further exemplary embodiments, digitized binary-input user interface 200 may be recursively updated based on user input. For example, as illustrated in FIG. 2, inputs beginning with a 0 correspond to actions, commands, characters and letters. If a user enters a 1 first, digitized binary-input user interface may be recursively updated to display a different list of quasi-unique audio-linguistic concepts in the columns that correspond to binary strings beginning with 1. For example, in some exemplary embodiments, binary strings beginning with a 1 may correspond to phrases, words or numbers.

In yet further exemplary embodiments, digitized binary-input user interface 200 may be continuously recursively updated to display only quasi-unique audio-linguistic concepts which match a user's inputs. For example, as a user continues to enter a binary string, digitized binary-input user interface 200 may be continuously recursively updated to display only those quasi-unique audio-linguistic concepts which match the current inputs.

As shown in FIG. 2, digitized binary-input user interface 200 also contains text box 10 and current input portion 45. As a user enters characters (either 1s or 0s), the character will appear in current input portion 45. Characters may either be for commands, such as the “Main Menu” option and other options shown in the first column of communicative selection portion 70 or quasi-unique audio-linguistic concepts, such as the options illustrated in the second through third columns shown in FIG. 2. Once nine characters corresponding to an option displayed on digitized binary-input user interface 200 are entered, the action will occur or the phrase, word, letter or number will appear in text box 10.

There are many ways in which a user may input characters (1s and 0s) to operate adaptive communication device with telephonic interface capabilities 900 using digitized binary-input user interface 200. If a user is able to switch between pressing two or more buttons, a user may interact with digitized binary-input user interface 200 in a two-button mode, as illustrated in FIG. 2, where a movement transducer contains one depressible button which corresponds to a 1, and a second depressible button which corresponds to a 0. For example, a user may use a mouse with a right click corresponding to a 1, and a left click corresponding to a 0 as a movement transducer. In further exemplary embodiments, larger, separate buttons may be used, such as button box 28. In the exemplary embodiment shown, button box 28 is a box containing three depressible buttons, one corresponding to a 1, the second corresponding to a 0, and the third corresponding to a ‘clear all’ function. As illustrated in FIG. 2, button box 28 has a wired connection with adaptive communication device with telephonic interface capabilities 900. In further exemplary embodiments, button box 28, or other binary-input device, may be adapted to wirelessly communicate with adaptive communication device with telephonic interface capabilities 900.

In still further exemplary embodiments, a button may be an object or device other than a depressible button that may be manipulated to provide an input character may be used as a movement transducer. For example, in addition to a depressible button, a button may include, but is not limited to, a turning mechanism, spinning mechanism, touch pad, squeeze trigger, switch and any other structure or device known in the art to provide a measurable manipulation, such as a suck-and-blow device. A button may also manipulated by any part of the body. For the purposes of two-button binary input, a single structure or device capable of receiving at least two distinct inputs may also be used, such as a lever which may be switched up and down or left and right.

Additionally, a button may include structures or devices that are not physically manipulated, including, but not limited to, a microphone, camera or other sensor. For example, a user may be able to select characters using a tone picked up by a microphone or by making a movement observed by a camera.

In still further exemplary embodiments, a movement transducer may be attached to a user's body.

While two buttons would be sufficient to allow a user to enter two characters, additional buttons may be used in further exemplary embodiments to, for example, provide an easy way for a user to erase text from text box 10 or return to a menu. In yet further exemplary embodiments, multiple buttons may be used to facilitate using the phone. For example, a designated button may allow a user to switch between digitized phone interface 400 (not shown) and digitized binary-input user interface or allow a user to select a pre-assembled greeting.

When a user is not able to switch between two buttons, or may only be capable of providing one electro-mechanically discernable movement, adaptive communication device with telephonic interface capabilities 900 may be used with a single-button input for digitized binary-input user interface 200. In single-button mode, options are still selected by entering a series of characters of a predetermined length, but instead of manipulating one of two buttons to enter either a 1 or a 0, a single button is manipulated for a time, resulting in an input method slightly more similar to Morse code.

In an exemplary embodiment using single-button input, a user may quickly depress a button to indicate a “1,” while holding down a button for a longer period to indicate a “0,” or vice versa. In further exemplary embodiments, a button may be any structure or device known in the art that may be manipulated for a timed duration, including, but not limited to, a standard push button, a spring, a pressure-sensing device, or a blow or suck device. In still further exemplary embodiments, a button may include any device or structure known in the art to receive variable intensity input, including, but not limited to, a pressure-sensing device, knob, turning device or spring.

A user may use adaptive communication device with telephonic interface capabilities 900 with single-button mode for digitized binary-input user interface 200 as long as a user is capable of at least one electro-mechanically discernable movement with any part of the body. A movement transducer used with single-button mode for digitized binary-input user interface 200 is capable of sensing multiple facets of at least one electro-mechanically discernable movement, such as intensity, duration, direction, tone or any other facet of an electro-mechanically discernable movement to create a dynamic input.

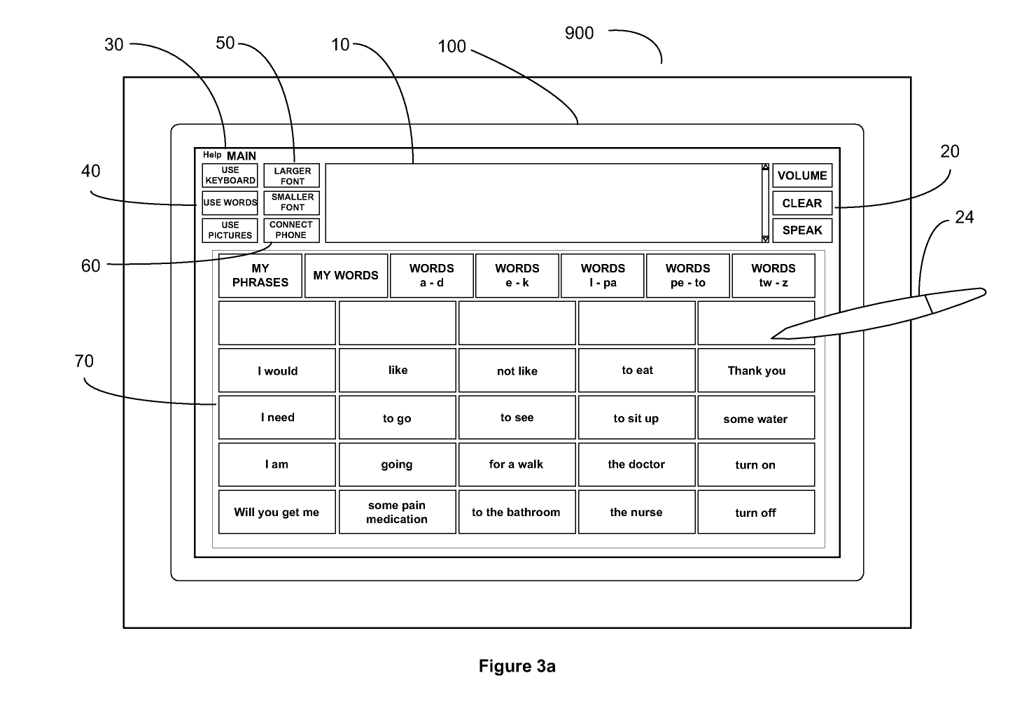

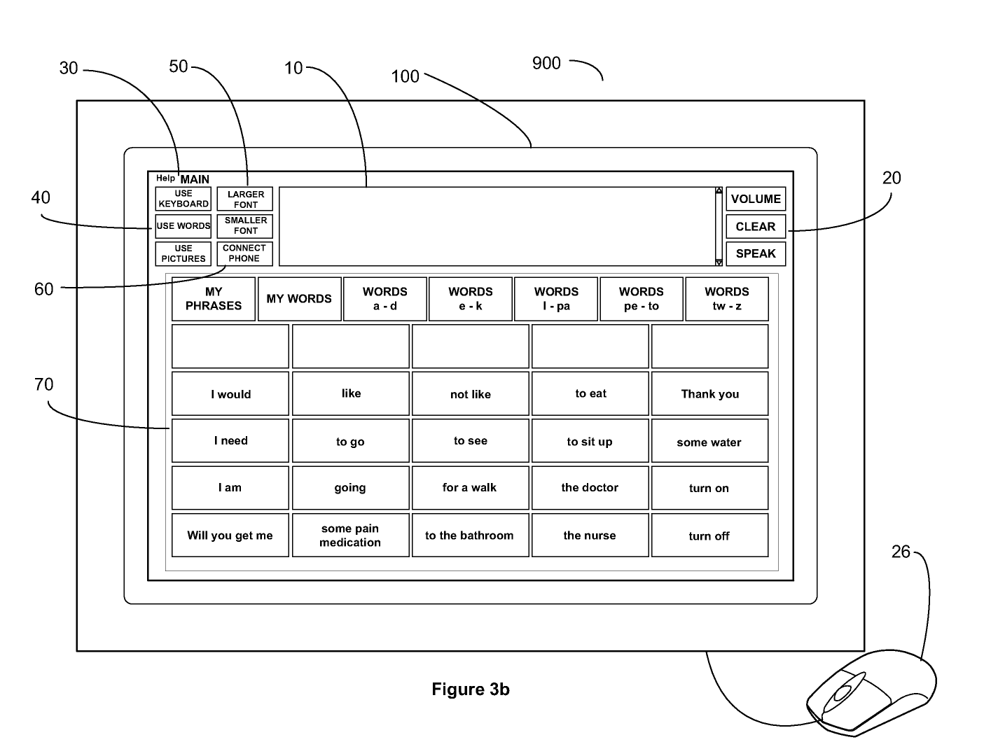

FIG. 3a illustrates an exemplary embodiment of a digitized cursor-input user interface 100 with phrases for an adaptive communication device with telephonic interface capabilities 900 adapted to be used with stylus 24. FIG. 3b illustrates digitized cursor-input user interface 100 with phrases to be used with mouse 26.

As illustrated in FIGS. 3a and 3b, digitized cursor-input user interface 100 contains communicative selection portion 70 from which a user may select phrases, words, letters or pictures. In the exemplary embodiments shown in FIGS. 3a and 3b, communicative selection portion 70 contains phrases, which are under the tab “MY PHRASES.” Common phrases may come pre-loaded on adaptive communication device with telephonic interface capabilities 900 or be added by a user based on user preference. In still further exemplary embodiments, phrases may be selected based on statistical relevance to a user's condition or frequent use. Other tabs on communicative selection portion 70 allow a user to select other digitized cursor-input user interfaces, each with different selection options on communicative selection portion 70. For example, the “MY WORDS” tab allows a user to select words, which may either come pre-loaded on adaptive communication device with telephonic interface capabilities 900 or added by a user based on user preference and what words a user may use frequently.

Communicative selection portion 70 may also display an alphabetized listing of the most common words used in the English language by selecting tabs “WORDS a-d,” “WORDS e-k,” “WORDS l-pa,” “WORDS pe-to,” and “WORDS tw-z.” In still further exemplary embodiments, words may be displayed based on statistical relevance to a user's condition or frequency of use.

As illustrated in the exemplary embodiments shown in FIGS. 3a and 3b, digitized cursor-input user interface 100 also contains text box 10. When a user selects options from communicative selection portion 70, the words or letters appear in text box 10 in the order selected. Communication control buttons 20 allow a user to “CLEAR” all input from text box 10 or tell adaptive communication device with telephonic interface capabilities 900 to audibly output all input in text box 10 by selecting the “SPEAK” button. Communication control buttons 20 also allow a user to increase or decrease the “VOLUME” of audible output.

The exemplary embodiments in FIGS. 3a and 3b also contain main navigation buttons 30, which include a “Help” button and a “MAIN” option that takes a user to a main interface. The “Help” option allows a user to receive basic trouble-shooting directions and answers to common questions involving basic use or common problems. Main interface (not shown) allows a user to select between different digitized interfaces and perform simple maintenance and calibrations.

The exemplary digitized cursor-input user interfaces illustrated in FIGS. 3a and 3b also contain digitized cursor-input user interface selection options 40, font buttons 50 and phone selector 60. Digitized cursor-input user interface selection options 40 allow a user to easily switch options displayed on communicative selection portion 70 between words/phrases (as currently illustrated in FIGS. 3a and 3b) by selecting “USE WORDS,” a keyboard by selecting “USE KEYBOARD,” and pictures by selecting “USE PICTURES.” Exemplary embodiments of digitized cursor-input user interfaces using pictures and a keyboard will be discussed below.

Font buttons 50 allow a user to increase or decrease the font size of words, letters and images appearing on digitized cursor-input user interface 100. Phone selector 60 allows a user to switch from digitized cursor-input user interface 100 to phone interface 400 (not shown).

In the exemplary embodiment shown in FIG. 3a, adaptive communication device with telephonic interface capabilities 900 is adapted to be used with stylus 24. As illustrated in FIG. 3a, stylus is a pen-shaped device used to manipulate a cursor on digitized cursor-input user interface 100. Stylus 24 may be hollow, contain internal circuitry or be weighted for the comfort of a user. In still further exemplary embodiments, stylus 24 may be of any shape to provide a user with an easier grasping surface. In yet further exemplary embodiments, stylus 24 may contain a grasping component, such as a contour or other gripping structure, or may be further configured with a strap or other device to attach stylus to a user's hand, finger or other body part.

In the exemplary embodiment shown in FIG. 3a, a user moves stylus 24 to select the desired quasi-unique audio-linguistic option and taps digitized cursor-input user interface 100 to make the selection.

In the exemplary embodiment shown in FIG. 3a, digitized cursor-input user interface 100 uses electromagnetic induction technology to sense the location of stylus 24. Digitized cursor-input user interface 100 generates an electromagnetic signal through wires located under the screen, which is received by an LC circuit in stylus 24. The LC circuit in stylus 24 then generates a signal which is received by digitized cursor input user interface 100. Stylus 24, therefore, does not need to touch digitized cursor-input user interface 100 in order for its position to be determined.

In still further exemplary embodiments, digitized cursor-input user interface 100 may utilize an electrostatic or capacitive signal to communicate with stylus 24. In yet further exemplary embodiments, digitized cursor-input user interface 100 may be a touch screen.

In still further exemplary embodiments, a user may use another object such as a mouse, pointer device, finger or other object to physically indicate a selection on digitized cursor-input user interface 100. In further exemplary embodiments, as shown in FIG. 3b, mouse 26 may be used with adaptive communication device with telephonic interface capabilities 900, and a user may use mouse 26 or other similar pointer device to move a cursor or other icon over an option and press a button to select that option.

In some cases, however, a user may not be able to press against digitized cursor-input user interface 100 or push a mouse button, but might only be able to move stylus 24, mouse 26 or other similar object in a vertical or horizontal plane. To accommodate users lacking the ability to generate enough force to depress a button or tap a screen, further exemplary embodiments of digitized cursor-input user interface 100 may allow options to be selected through hovering capability. A user need only manipulate stylus 24, mouse 26 or other similar device over the desired option and leave it there for a duration which may be set by the user. After the desired option has been indicated for the duration, the option will be selected. For example, a user may set a hover-selection time for 2 seconds, in which case a user may move a stylus over the “I would” option and leave it there for 2 seconds, after which the words “I would” will appear in text box 10. Hover-selection time may be set for any length of time desired by a user, although the longer the hover-selection time, the longer it will take to input the desired options.

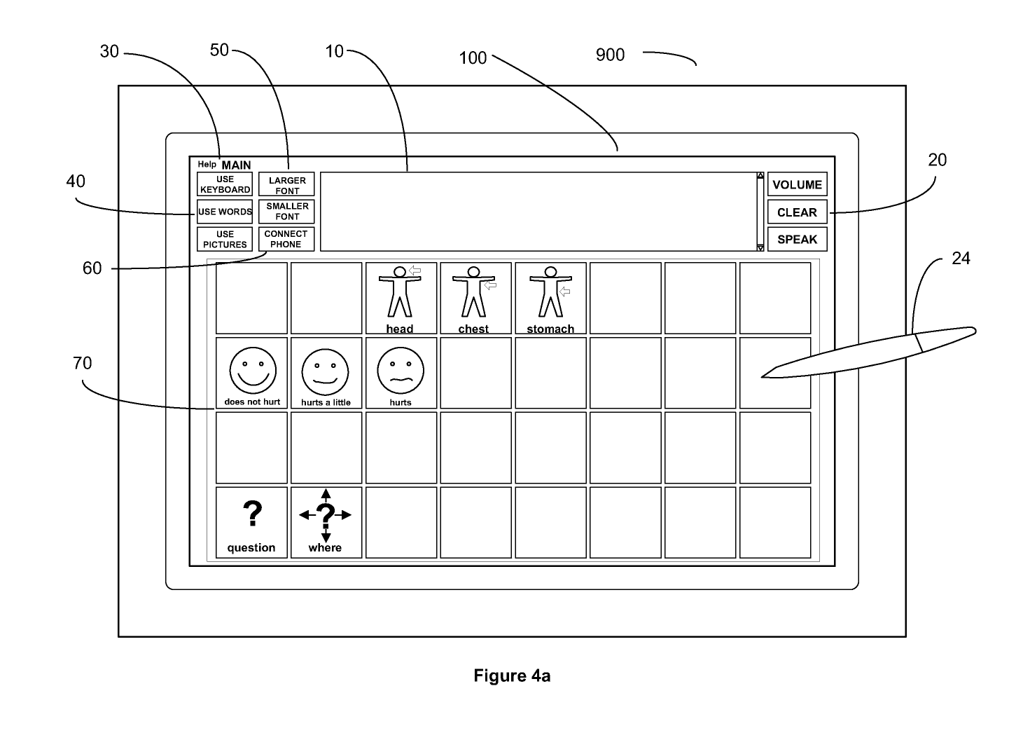

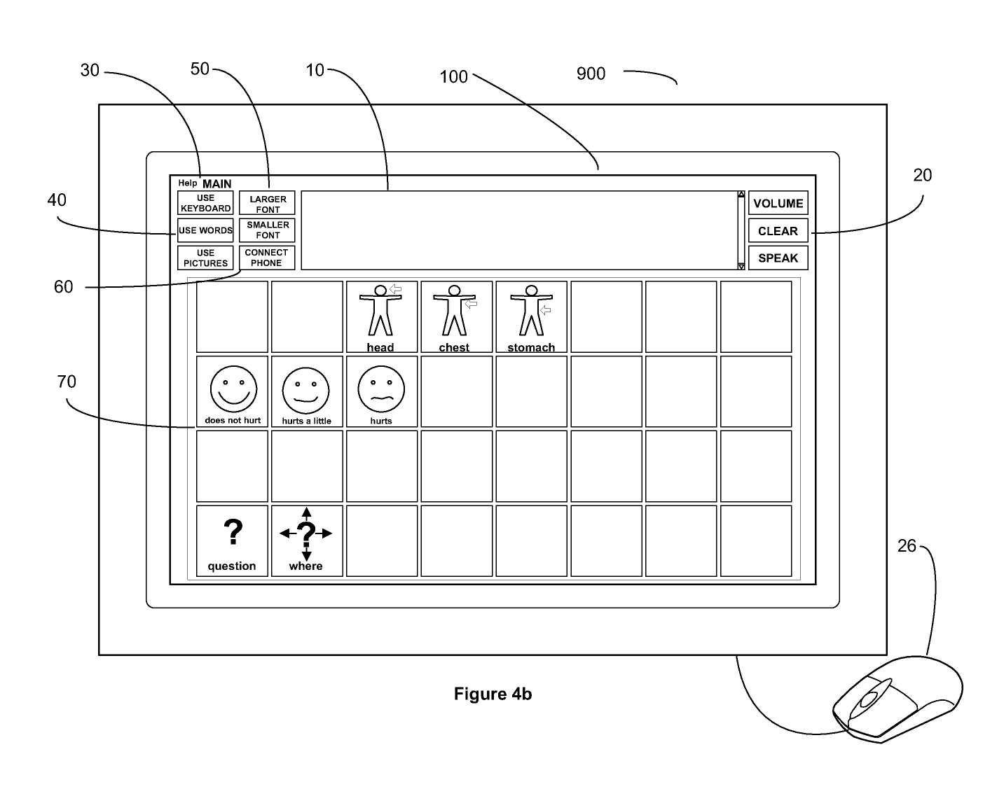

FIG. 4a illustrates an exemplary embodiment of a digitized cursor-input user interface 100 with pictures for an adaptive communication device with telephonic interface capabilities 900 adapted to be used with stylus 24. FIG. 4b illustrates an exemplary embodiment of a digitized cursor-input user interface 100 with pictures for an adaptive communication device with telephonic interface capabilities 900 adapted to be used with mouse 26.

As illustrated in FIGS. 4a and 4b, digitized cursor-input user interface 100 with communicative selection portion 70 displaying pictures and images instead of phrases or words. Exemplary communicative selection portion 70 shown in FIGS. 4a and 4b contains only a few exemplary images. For example, as illustrated in the exemplary embodiment shown in FIGS. 4a and 4b, communicative selection portion 70 contains selection buttons showing people with arrows pointing to parts of the body to indicate “head,” “chest,” or “stomach.” A user may select the desired portion of the body and the word corresponding with the selection will appear in text box 10. A user with limited literacy may be able to use adaptive communication device with telephonic interface capabilities 900 by using such pictures. In further exemplary embodiments, communicative selection portion 70 may contain more or fewer images corresponding to words or phrases to be used by a user.

In some exemplary embodiments, some picture options may come pre-loaded on adaptive communication device with telephonic interface capabilities 900. Pre-loaded options may contain pictures illustrating basic common words, or be more tailored toward a specific setting, such as a hospital or other care-giving setting, to include options such as the displayed options “does not hurt,” “hurts a little” and “hurts.” In further exemplary embodiments, a user may be able to select illustrations to indicate words most often used by user. Images may also be provided based on statistical relevancy to a user's condition.

In the exemplary embodiments shown in FIGS. 4a and 4b, there is only one page or screen of images on communicative selection portion 70. In further exemplary embodiments, communicative selection portion 70 may contain tabs, similar to those found when using the interface described in FIGS. 3a and 3b, which allow a user to store and use more words or phrases. Pictures may be stored and organized by topic, such as “doctor” or “food,” alphabetically, or in any other navigatable arrangement.

FIGS. 4a and 4b also shows communication control buttons 20, main navigation buttons 30, digitized cursor-input user interface selection options 40, font buttons 50 and phone selector 60, arranged as shown in FIGS. 3a and 3b. In further exemplary embodiments, elements displayed on digitized cursor-input user interface 100 may be differently arranged to accommodate, for example, a user with more use of one side of his or her body. Text box 10 may be located on a portion of digitized cursor-input user interface 100 that user has trouble physically reaching. In still further exemplary embodiments, elements displayed on digitized cursor-input user interface 100 may be arranged to meet other user-specific requests.

In the exemplary embodiments shown in FIGS. 4a and 4b, stylus 24 and mouse 26 are used as described with FIGS. 3a and 3b. In still further exemplary embodiments, a user may use any structure or device known in the art to manipulate a cursor.

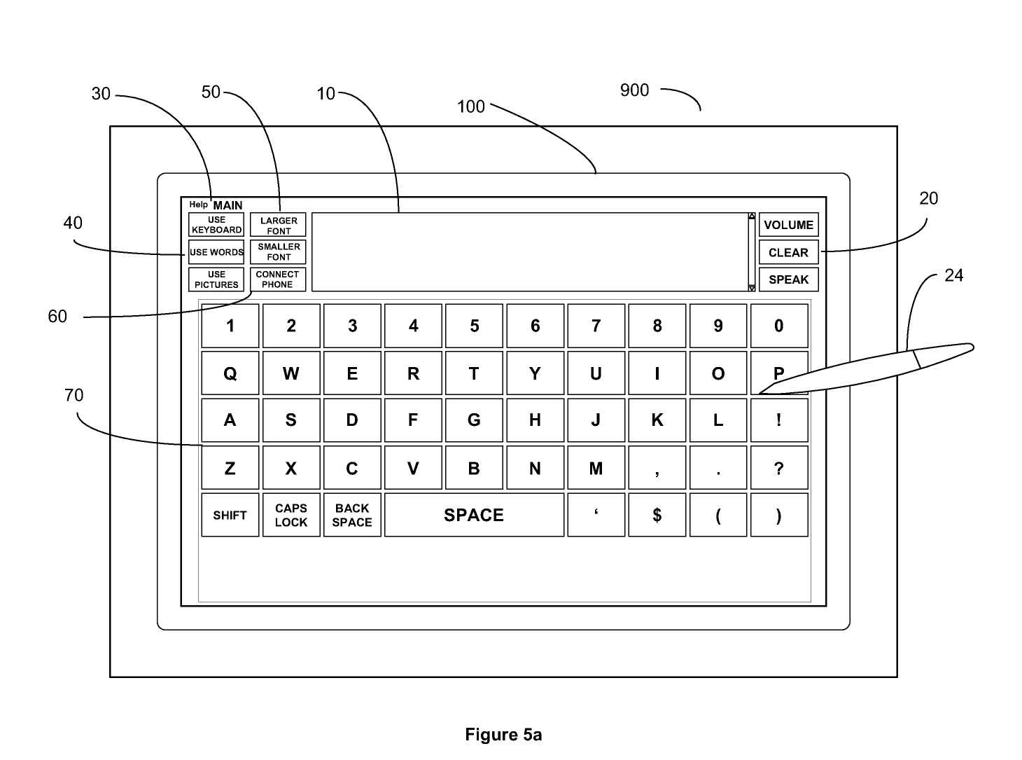

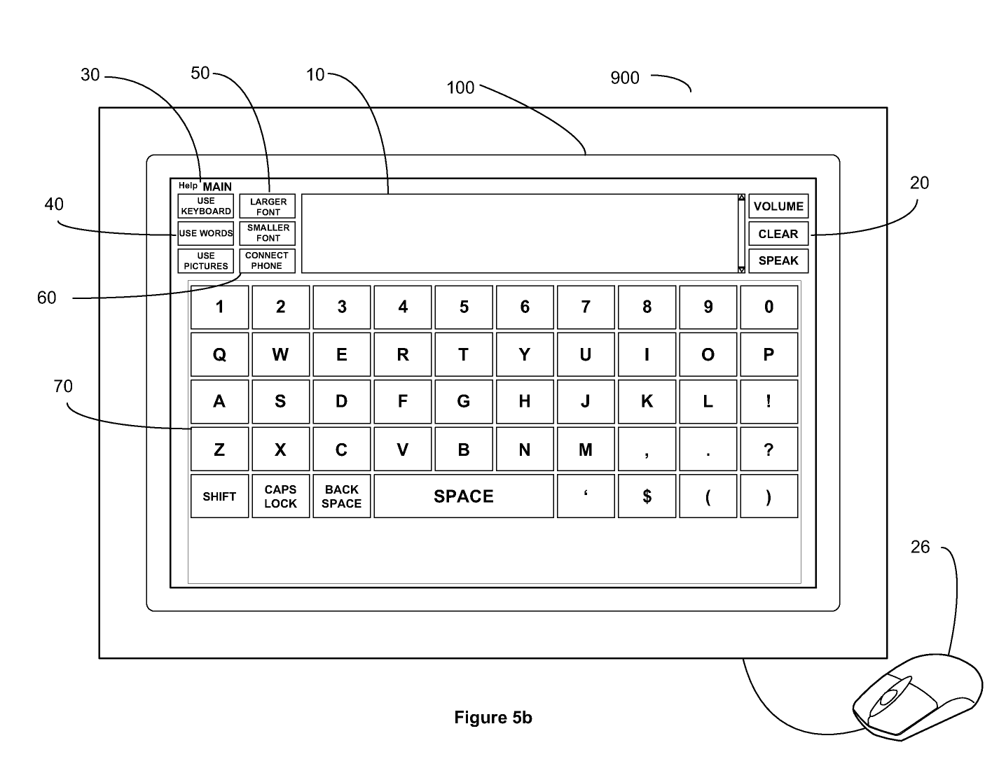

FIG. 5a illustrates an exemplary embodiment of a digitized cursor-input user interface 100 with a keyboard for an adaptive communication device with telephonic interface capabilities adapted to be used with stylus 24. FIG. 5b illustrates an exemplary embodiment of a digitized cursor-input user interface 100 with a keyboard for an adaptive communication device with telephonic interface capabilities adapted to be used with mouse 26.

As illustrated in FIGS. 5a and 5b, communicative selection portion 70 of digitized cursor-input user interface 100 displays a QWERTY-style keyboard with common symbols and commands located in the same row as the space bar. In other exemplary embodiments, letters may be arranged alphabetically. In still further exemplary embodiments, communicative selection portion 70 with keyboard display may be arranged under multiple tabs, similar to those described in FIG. 1. For example, tabs may display a standard QWERTY keyboard, alphabetical arrangement of letters, numbers, or symbols. In yet further exemplary embodiments, letters, numbers or symbols may be arranged according to statistical frequency of usage or user preference.

FIGS. 5a and 5b also show communication control buttons 20, main navigation buttons 30, digitized cursor-input user interface selection options 40, font buttons 50 and phone selector 60.

As illustrated in FIGS. 5a and 5b, a user would use stylus 24 and mouse 26 as described with FIGS. 3a and 3b, above.

The exemplary embodiments in FIGS. 3a-5b illustrate exemplary arrangements of a digitized cursor-input user interface 100. Users may use any device or structure adapted to function as a cursor or pointer to input information using digitized cursor-input user interface 100. For example, a user may use a finger if digitized cursor-input user interface 100 is a touch screen, or stylus 24. However, some users may not be able to control movements with enough accuracy to avoid touching the screen. Digitized cursor-input user interface 100 may therefore be used with a stylus or any other object or device known in the art for allowing a user to tap the screen to make selections.

In still further exemplary embodiments, digitized cursor-input user interface 100 may be adapted for use by users who cannot vertically hold or maneuver an object. In such exemplary embodiments, a user may control a cursor icon or other graphic with mouse 26, a horizontal touchpad, a ball roller, or any other device known in the art to manipulate a cursor to make selections.

In some cases, a user of adaptive communication device with telephonic interface capabilities 900 may not be able to generate force to press or push against an object, and may only be capable of maneuvering a cursor-style object, whether in a vertical or horizontal plane. In such cases, digitized cursor-input user interface may be adapted with hovering capability to allow user selections. For example, a user may use a stylus (or other cursor-manipulating structure or device) and hover over the desired selection. After the cursor or device hovers over an option for a period of time, the option will be selected.

Hovering times may be set at a default or changed to suit a particular user. For example, if a user is not able to steadily hold in a position for more than a second, the hover time may be set to half a second or other relevant value. Alternatively, if a user moves a cursor or device slowly, the hover time may be set for a longer period, such as 2 or 3 seconds. In further exemplary embodiments, a hover time may be restored to a default setting by accessing an appropriate menu option.

In still further exemplary embodiments, users may be able to switch between touch screen or standard point-and-click operation and hovering capability. When used with hovering capability, digitized cursor-input user interface may not respond to touching or clicking.

When using adaptive communication with digitized cursor-input user interface 100, a pointing device or cursor need not be manipulated by hand. Some users may not be able to use their hands, arms, or even upper body. In such cases, a pointing device or other method for manipulating a cursor may be adapted to be used by a part of the body other than a hand, including, for example, but not limited to, toes, feet, elbows, shoulders, knees, arms, legs, heads, mouth, tongue or any other part of the body a user may have regular control over to engage with a device capable of manipulating a cursor to select an option.

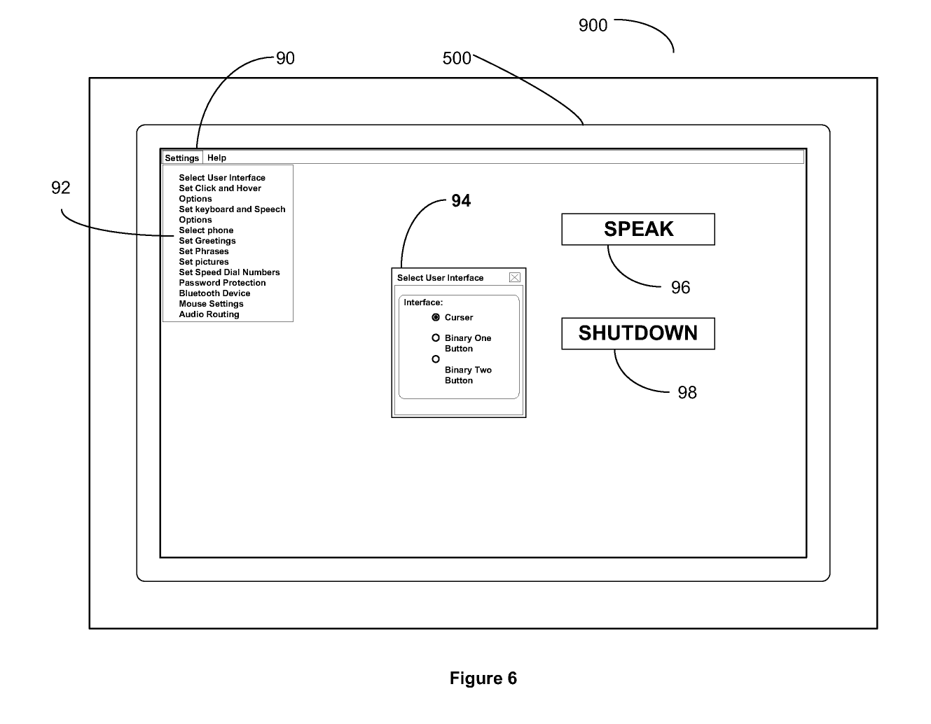

FIG. 6 illustrates an exemplary embodiment of a digitized user interface selection interface 300 for an adaptive communication device with telephonic interface capabilities 900. Digitized user interface selection interface 300 is displayed when adaptive communication device with telephonic interface capabilities 900 is initially turned on and may be returned to by selecting “Main” or “Main Menu” options from other digitized user interfaces, such as the exemplary digitized user interfaces described in FIGS. 2-5b.

Digitized user interface selection interface 300 contains “SPEAK” button 96 which takes a user to a digitized user interface for selecting phrases, words, letters or numbers for communicating, such as the exemplary digitized user interfaces described in FIGS. 2-5b. Digitized user interface selection interface 300 also contains settings menu option 90, which opens drop-down settings menu 92. Drop-down settings menu 92 contains a list of programmable settings a user may specifically set or program. For example, in the exemplary embodiment shown in FIG. 6, settings menu option 90 allows a user to change between a digitized cursor-input user interface and a digitized binary-input user interface, such as those described in the exemplary embodiments shown in FIGS. 2-5b. A user uses drop-down settings menu 92 and selects “Select User Interface,” which will open “Select User Interface” box 94. A user can then select either a curser interface, binary one button interface or binary two button interface. After a user interface is selected, the “SPEAK” button will take a user to the selected interface.

User may change other settings using drop-down settings menu 92, including, but not limited to, changing between click and hovering options when using adaptive communication device with telephonic interface capabilities 900 with digitized cursor-input user interface 100, changing speaking voices, changing between QWERTY-style and alphabetical keyboards, managing account information (i.e., passwords, Bluetooth devices, mouse settings, audio), adding speed dial numbers, enabling or disabling a phone and setting greetings, phrases or pictures. Selecting options from drop-down settings menu 92 may open additional windows, such as “Select User Interface” box 94 shown in FIG. 6 in order to manage desired properties of adaptive communication device with telephonic interface capabilities.

Digitized user interface selection interface 300 also contains “SHUTDOWN” button 98.

In the exemplary embodiment shown in FIG. 6, the background of digitized user interface selection interface 300 is shown as a solid box. In further exemplary embodiments, the background of digitized user interface selection interface 300 may be a solid color or patterned. In still further exemplary embodiments, the background may contain a graphic, picture or textual information. For example, a user may be able to upload personal pictures or images to use as a background for digitized user interface selection interface 300. In yet further exemplary embodiments, the background may contain identifying information, including, but not limited to, the user's name, address or phone number in case adaptive communication device with telephonic interface capabilities 900 is lost or stolen.

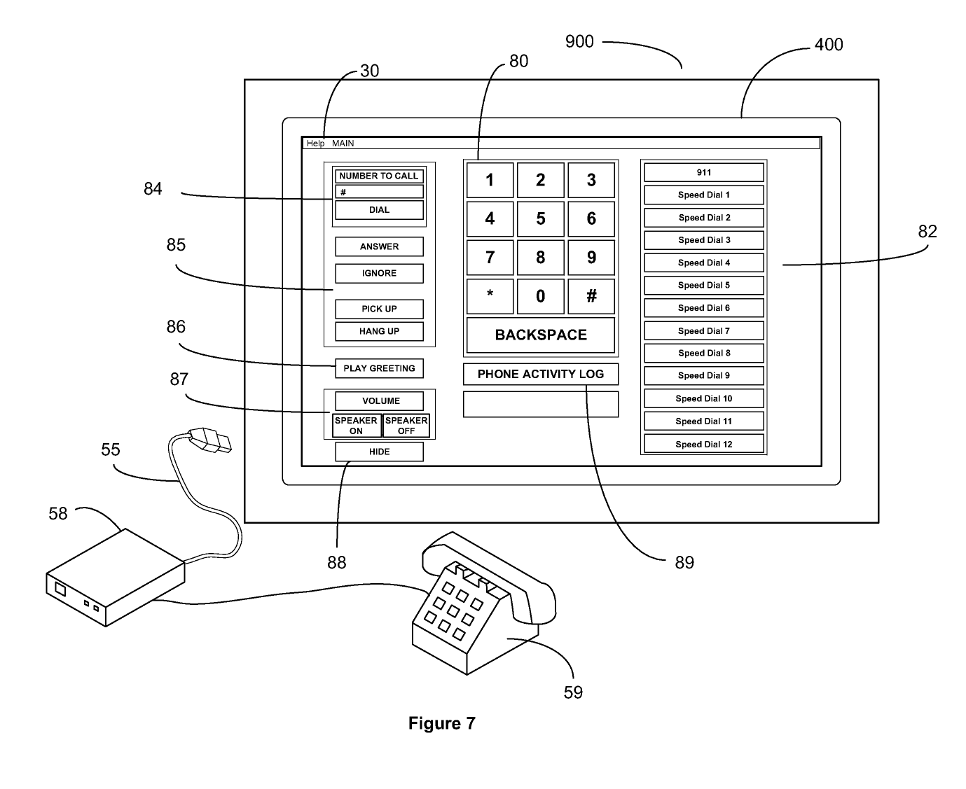

FIG. 7 is an exemplary embodiment of digitized telephonic user interface 400 with adaptive communication device 900 connected to an electronic interface module and a POTS (plain old telephone signal) phone line. In the exemplary embodiment shown, adaptive communication device with telephonic interface capabilities 900 includes USB port (not shown), USB cable 55 and electronic interface module 58, which allow the adaptive communication device 900 to interface with telephone 59 without the need to position adaptive communication device with telephonic interface capabilities 900 in close proximity to telephone 59.

As shown in the exemplary embodiment illustrated in FIG. 7, digitized telephonic user interface 400 contains speed dial bank 82 which contains a series of telephone numbers which may be selected by a single click, hover or binary entry. In the exemplary embodiment shown, the first number in speed dial bank 82 is 911. Because adaptive communication device with telephonic interface capabilities 900 is designed for use by individuals with medical hindrances to usual vocal communication, 911 is an important number to have on speed dial. In other exemplary embodiments, however, 911 need not be included in speed dial bank 82 or may be located in a different position within speed dial bank 82. In some exemplary embodiments, speed dial bank 82 may include pre-set speed dial numbers, while in other exemplary embodiments, a user may individually set and change speed dial numbers.

After a telephone number has been set in speed dial bank 82, speed dial bank 82 may list the contact by telephone number, such as 911, name or other identifier. In still further exemplary embodiments, speed dial bank 82 may include pictures or graphics corresponding to a given number in speed dial bank 82. For example, a user may include family members' telephone numbers in speed dial bank 82 and use a family member's picture as an indicator of the telephone number.

Digitized telephonic user interface 400 also includes keypad 80 for a user to enter telephone numbers other than those located in speed dial bank 82. The digitized telephonic user interface 400 illustrated in FIG. 7 is adapted to be used with cursor-input. To enter a phone number, a user uses a stylus, mouse or other device, as described above, to select numbers from keypad 80. Once a number from keypad 80 is selected, it appears in call box 84. The user selects “DIAL” after the complete telephone number has been entered and appears in call box 84.

Once a call is connected, the same interface (digitized telephonic user interface 400) may be adapted to transmit the dual tone multiple frequencies (DTMF tones) which are required to enter PIN numbers or other information over a touch tone phone.

Also shown on digitized telephonic user interface 400 are telephone operation buttons 85. Telephone operation buttons 85 allow a user to carry out basic telephone operations with digitized telephonic user interface 400. For example, a user may answer a call, pick up and hang up the phone or ignore an incoming call. In further exemplary embodiments, telephone operation buttons may also allow a user to place a caller on hold, use three-way calling or transfer a call to a different phone line.

“PLAY GREETING” button 86 is also shown on digitize telephone user interface 400, which allows a user to play a pre-setup greeting in response to an incoming call or an answered dialed call. A pre-setup greeting may include, for example, a message informing the person on the other end that the user is using adaptive communication device with telephonic interface capabilities 900 and explaining how the conversation may be affected by that use. A pre-setup greeting may also be specifically tailored for a given situation, such as an emergency situation requiring a 911 call, informing whoever answers the phone of the users name, condition and location. While in the exemplary embodiment shown in FIG. 7 there is only one “PLAY GREETING” button 86, further exemplary embodiments may include more “PLAY GREETING” buttons, which may be custom setup for different situations. For example, pre-setup greetings may be created for family, friends, unknown callers, emergency situations, telemarketers, medical calls, children and any other group of people or situations a user desires to have a pre-setup greeting created for.

Located below “PLAY GREETING” button 86 in FIG. 7 are audio control buttons 87, which allow a user to change the volume or turn speakers on and off, and digitized telephonic user interface “HIDE” button 88. Digitized telephonic user interface “HIDE” button 88 allows a user to hide digitized telephonic user interface 400 in order to return to a different interface, such as digitized cursor-input user interface 100 or digitized binary-input user interface 200. Without being able to return to an input user interface, a user would not be able to respond to a caller. While on a call, user enters information using digitized cursor-input user interface 100 or digitized binary-input user interface 200 to enter phrases, words, letters or numbers to carry on a conversation with a caller.

In other exemplary embodiments, digitized telephonic user interface 400 may include statistically common phrases used during phone conversations, so that a user does not need to change between digitized telephonic user interface 400 and other input interfaces as frequently.

Digitized telephonic user interface 400 also includes phone log 89. Phone log 89 stores information pertaining to a current call or past calls, including, but not limited to, call duration and telephone number. In further exemplary embodiments, phone log 89 may contain additional information, including, but not limited to, frequency with which a telephone number has called or been dialed, caller ID information, time of the call, time of previous calls with that number, and whether an incoming call was missed or answered.

In still further exemplary embodiments, digitized telephonic user interface 400 may also include buttons allowing a user to use voicemail, such as check, replay, save or delete message, change a voicemail greeting, or turn voicemail on and off. In yet further exemplary embodiments, adaptive communication device with telephonic interface capabilities 900 may include a separate digitized interface for interacting with a voicemail system.

Digitized telephonic user interface 400 also includes main navigation buttons 30.

In the embodiment shown adaptive communication device with telephonic interface capabilities 900 has buffering capability and is connected to a telephone line using a standard telephony module of the type known in the art. In alternative, adaptive communication device with telephonic interface capabilities 900 may utilize an internal telephony card or functionally equivalent telephony interface, or may be configured to interface with a wireless telephone device. In still other embodiments, adaptive communication device with telephonic interface capabilities 900 may be enabled by any wireless Internet protocol known in the art (e.g., infra-red, Blue-tooth™, WAP, etc.)

The digitized interfaces described in FIGS. 6 and 7 are shown adapted to be used in cursor-input mode. In further exemplary embodiments, both digitized user interface selection interface 300 and digitized telephonic user interface 400 may be adapted to be used in binary-input mode, as described with FIGS. 1 and 2.

The exemplary embodiments illustrated in FIGS. 1-7 show digitized user interfaces with arranged buttons and display areas. In further embodiments, buttons and display areas may be in different locations on digitized interfaces, and may be specifically arranged to accommodate a user with a given handicap. For example, if a user has limited mobility but still wishes to use adaptive communication device with telephonic interface capabilities 900 with cursor-input, interfaces may be setup with all selection buttons located in a single are on the interfaces, and display areas located in portions a user is not able to manipulate a cursor to reach.

The exemplary embodiments described in FIGS. 1-7 show adaptive communication device with telephonic interface capabilities 900 designed for general use by individuals with disabilities affecting their abilities to communicate. In other exemplary embodiments, adaptive communication device with telephonic interface capabilities 900 may be designed with limited functionality for a specific use, such as in a hospital or other healthcare facility to specifically allow a user to communicate with healthcare providers. In further exemplary embodiments, functionality may be added or combined with other devices (e.g., to minimize production costs, learning curves, qualify Medicare reimbursement, etc.)

In FIGS. 1-7, adaptive communication device with telephonic interface capabilities 900 is also shown as a substantially rectangular housing having a rectangular screen to display digitized user interfaces. Adaptive communication device with telephonic interface capabilities 900 may have Bluetooth, wifi or other wireless communication capabilities to communicate with additional components of adaptive communication device with telephonic interface capabilities 900, such as buttons, a stylus, a mouse or any other component which may be used with adaptive communication device with telephonic interface capabilities 900.

In further exemplary embodiments, adaptive communication device with telephonic interface capabilities 900 includes one or more ports, including, but not limited to, USB ports, TRS connectors, Ethernet ports, and any other port or jack known in the art to allow a user to connect other external devices or components to adaptive communication device with telephonic interface capabilities 900. For example, adaptive communication device with telephonic interface capabilities 900 may be connected to a larger screen for use by individuals with visual impairments.

In still further exemplary embodiments, adaptive communication device with telephonic interface capabilities 900 may contain a power adaptor or battery compartment to power adaptive communication device with telephonic interface capabilities 900.

Adaptive communication device with telephonic interface capabilities 900 may also include a hardware storage component and processor within its housing to store and allow modification of quasi-unique audio-linguistic concepts.

To provide a user with a stable working platform, adaptive communication device with telephonic interface capabilities 900 may be adapted to be mounted to a stable surface, such as a table, wheelchair arm, bed stand, bed frame, wall, ceiling or other surface. Housing of adaptive communication device with telephonic interface capabilities 900 may contain structures or devices for mounting adaptive communication device with telephonic interface capabilities 900, or, in some exemplary embodiments, adaptive communication device with telephonic interface capabilities 900 may need to be modified in order to secure it to a desired surface. In still further exemplary embodiments, adaptive communication device with telephonic interface capabilities 900 may come with a mounting structure that is a stand that may be used on various surfaces and securely removably attached to a wheelchair or other mobile device a user may use to move.

In the exemplary embodiments shown in FIGS. 1-7, adaptive communication device with telephonic interface capabilities 900 is shown as a basic device with little decorative or customizable options. In further exemplary embodiments, select aspects of adaptive communication device with telephonic interface capabilities 900 may be customized. For example, a user may choose the vocal characteristics of the audible output, such as whether a man or woman speaks the inputs. In still further embodiments, users may be able to choose accents or other vocal characteristics. In some exemplary embodiments, users may also be able to select vocally-produced sounds, such as laughter, snickering, snorting, crying, noises of frustration and other sounds that are not words a user may wish to express. In yet further exemplary embodiments, users may be able to incorporate sounds, such as clicks, bings, or other indicators of a selection being made.

In still other exemplary embodiments, users may also be able to customize backgrounds of digitized user interfaces by incorporating selected graphics, pictures, images or words with personal meaning or value to the user. In further exemplary embodiments, users may also be able to select colors, such as background colors, font colors, and color themes for menus to create a visual effect pleasing to the user.

What is claimed is:

1. An adaptive communication device comprised of:
at least one movement transducer capable of detecting an electro-mechanically discernable movement of at least one body part of a user and sending a signal to at least one digitized user interface;
said digitized user interface further including a plurality of grid areas which corresponds to at least one quasi-unique audio-linguistic concept which is statistically relevant to a user's condition;
at least one electronic interface module which senses said at least one quasi-unique audio-linguistic concept and converts said at least one quasi-unique audio-linguistic concept into a plain old telephone service signal which is transmitted to a telephone; and
at least one sound emitting hardware component.

2. The device of claim 1 wherein said movement transducer is fixably and non-movably attached within a substantially hollow graspable housing having a length between one and twelve inches and having an outer diameter of less than one-half inch, said hollow graspable housing further including at least one grasping component.

3. The device of claim 2 wherein said grasping component is selected from the group consisting of a contoured molded component, a stylus, a handle, a strap, a clasp, a vise, a pressure sensitive closure component and combinations thereof.

4. The device of claim 1 which is further configured with a hardware storage component and processor so that said at least one quasi-unique audio-linguistic concept may be user-defined and stored and modified.

5. The device of claim 1 wherein said at least one movement transducer includes at least one LC circuit.

6. The device of claim 1 which is configured with a processor which determines the frequency of selection of said quasi-unique audio-linguistic concepts and assigns a placement to each of said quasi-unique audio-linguistic concepts on said digitized user interface.

7. The device of claim 1 which further includes at least one electronic sensing component adapted to detect and use an electro-mechanically discernable movement of at least one body part of a user to move a cursor.

8. The device of claim 1 which further includes at least one electronic sensing component adapted to detect and use an electro-mechanically discernable movement of at least one body part of a user to create a binary string of defined length.

9. The device of claim 1 which is further configured with software to be recursively updated based on binary input.

10. The device of claim 1 which is further includes a wireless communication component which is used to send a signal from said at least one movement transducer to a processor in communication with digitized user interface.

11. The device of claim 1 wherein said at least one movement transducer is a stylus and said digitized user interface is a capacitance screen that senses the location of said stylus.

12. The device of claim 1 wherein each of said at least one quasi-unique audio-linguistic concepts is further configured to be represented by a binary string of a defined length.

13. The device of claim 1 wherein said at least one movement transducer includes at least one depressible button and said user may set a first minimum and first maximum time duration to depress said depressible button that corresponds to a short depression and a second minimum and maximum time duration to depress said depressible button that corresponds to a long depression.

14. The device of claim 1 which is configured with software to allow said user to switch between binary-input and cursor-input modes.

15. The device of claim 1 wherein said housing is further configured with at least one port selected from the group consisting of a USB port, a TRS connector, an Ethernet port, a monitor connector, a pin connector and combinations thereof.

16. An adaptive communication apparatus comprised of:
at least one movement transducer capable of detecting an electro-mechanically discernable movement of at least one body part of a user;
a housing comprised of
at least one flat surface,
at least one port, and
at least one cover for said at least one port;
a screen on said at least one flat surface of said housing adapted to display a digitized user interface with a plurality of grid areas which corresponds to at least one quasi-unique audio-linguistic concept statistically relevant to said user's condition and receive a signal from said at least one movement transducer;
at least one electronic interface module which senses said at least one quasi-unique audio-linguistic concept and converts said at least one quasi-unique audio-linguistic concept into a plain old telephone service signal which is transmitted to a telephone;
at least one sound emitting hardware component; and
a power supply.

17. The apparatus of claim 16 wherein said apparatus is configured with a processor capable of receiving both cursor-input and binary-input.

18. The apparatus of claim 16 wherein said at least one movement transducer is selected from the group consisting of a depressible button, a stylus, a touch screen, a mouse, a motion sensor, a camera, a microphone, a knob, a roller ball, a track wheel, a touchpad, a lever, a pressure-sensing device, a spring and combinations thereof.

19. A method of communicating using an adaptive communication device comprised of the steps of:
displaying a plurality of quasi-unique audio-linguistic concepts on a digitized user interface;
completing at least one electro-mechanically discernable movement corresponding to at least one of said plurality of quasi-unique audio-linguistic concepts;
using a movement transducer to detect said at least one electro-mechanically discernable movement and convert said electro-mechanically discernable movement into an electrical signal;
transmitting said electrical signal to a processor;
recursively updating said digitized user interface based on said electrical signal;
audibly emitting said at least one of said plurality of quasi-unique audio-linguistic concepts through at least one sound emitting hardware component.

20. The method of claim 19 which further includes the step of using an electronic interface module to convert said at least one of said plurality of quasi-unique audio-linguistic concepts into a plain old telephone service signal and transmit said plain old telephone service signal to a telephone.
